(19) United States
(12) Patent Application Publication
(10) Pub. No.: US 2008/0059370 A1
(43) Pub. Date: Mar. 6, 2008

(54) System and Method for Third Party Payment Processing of Credit Cards

(75) Inventors: Alexander Sada, Greenbrae, CA (US); Philip J. Mikal, San Francisco, CA (US)

Correspondence Address: MORRISON & FOERSTER LLP, 1650 TYSONS BOULEVARD, SUITE 400, MCLEAN, VA, 22102, US

(73) Assignee: CARDIT, LLC, San Francisco, CA (US)

(21) Appl. No.: 11/668,864

(22) Filed: Jan. 30, 2007

Related U.S. Application Data
(60) Provisional application No. 60/823,951, filed on Aug. 30, 2006.

(51) Int. Cl. G06Q 40/00

(52) U.S. Cl. 705/40

(57) ABSTRACT

A system and method for enabling a debtor to charge a payment to a credit card when a creditor does not accept credit card payments is provided. The system comprises a customer interface, an approval engine, a scheduling engine, a service fee engine and schedule, a currency engine and schedule, a payment engine, and a reporting engine. The method comprises the steps of receiving customer data, approving the transaction, processing the credit card charge, and paying the creditor.

### REFERENCE TO RELATED APPLICATION

This application claims priority to, and the benefit of, U.S. Provisional Patent Application Ser. No. 60/823,951, filed on Aug. 30, 2006, the entire contents of which are incorporated herein by reference.

### FIELD OF INVENTION

The present invention generally relates to payment systems. In particular, the present invention relates to third parties making payments on behalf of a debtor where the debtor transfers money to the third party via credit card.

### BACKGROUND OF THE INVENTION

Over the years, transaction cards (e.g., credit cards, charge cards, smart cards, transponders, debit cards, gift cards, and the like) have become one of the most common forms of payment. Credit card companies generally guarantee the merchant will be paid on legitimate transactions regardless of whether the consumer pays their credit card bill. For this guarantee, credit card issuers generally charge the merchant a transaction processing fee, interchange fee, or other type of commission payment. In general, the fee can range from 0-5% depending on the issuer. While the percentage seems small, the fee can erode profits of some merchants, especially if the merchant offers larger priced items, or if the merchant is in the business of lending, leasing and/or the like.

For example, a mortgage provider or mortgage service typically does not accept credit cards for payment of a debtor's monthly payment. Many reasons may exist, namely, a creditor may not wish to encourage the debtor to incur more debt. Another reason is that the transaction fee may cut into the profits of the income stream afforded by the mortgage. Typically, large scale debts, such as mortgages, are traded as securities. Prices for these securities are based on many criteria, most notably the cash flow associated with the underlying mortgages included in the securities. In general, due to the structure of these debts and their respective payment terms, the cash flow is considered stable within a certain risk tolerance. This risk is generally represented by the interest rate. Enabling a debtor to charge a payment on a credit card incurs a transaction fee upon the company holding the mortgage note. As a result, the amount received from the income stream is decreased. Moreover, since the creditor will not be able to control the frequency with which a debtor would pay by credit card, the income stream is further destabilized. Similar reasoning applies to many industries which may securitize its payment streams (e.g., leasing companies) or require large periodic payments. Consequently, many merchants and creditors will typically not accept credit cards as a form of payment.

However, debtors have various reasons to use a credit card to pay for payment obligations. Many credit card issuers reward customers with points, miles, or cash back incentives that are based on the amount charged. Enabling one to charge these items increases the amount of rewards received. Alternatively, a debtor may have a career in which income is irregular, for example, a commission sales person. The ability to charge large payments to a credit card, thereby delaying payment for a month or two, helps one cope with irregular income flows. Thus, a need exists for the ability to charge payments to a credit card when a creditor refuses to accept credit card payments.

### SUMMARY OF THE INVENTION

The present invention addresses the disadvantages of the prior art systems by providing a third party payment credit card processing system for a debtor to charge all or a portion of a payment to a credit card, when a creditor does not accept credit card payments. In general, creditors will not accept some types of payments via a credit card. Some creditors, such as mortgage loan providers, do not want to pay the transaction charges associated with processing large payments. Doing so would reduce the profitability of the underlying revenue streams. However, many consumers may want to charge payments to their credit cards for a variety of reasons. For example, rewards points are generally issued for dollars charged on a card. Alternatively, because of the differences in rates, minimum payment amounts and other considerations, some consumers may want to take advantage of these differences to delay payments for a short period of time or pay a lower rate than the original debt. In any case, the present invention enables a debtor to use another tool in its money management toolbox.

The system comprises a customer interface, an approval engine, a scheduling engine, a service fee engine and schedule, a currency engine and schedule, a payment engine, and a reporting engine. In its exemplary embodiments, the system uses various engines and schedules to collect a customer's information, charge an amount to the customer's credit card, process the payment, and pay the creditor. The third party that deploys the present invention may sometimes be referred to herein as “service provider.”

An exemplary method receives customer data, approves the transaction, processes the credit card charge, and pays the creditor. As a result, a customer is able to a use credit card to pay creditors that do not usually accept credit card payments.

### DESCRIPTION OF FIGURES

A more complete understanding of the present invention may be derived by referring to the detailed description when considered in connection with the Figures, wherein like reference numbers refer to similar elements throughout the Figures, and:

FIG. 1 is a block diagram of a system in accordance with an exemplary embodiment of the present invention;

FIG. 2 is a block diagram of a method in accordance with an exemplary embodiment of the present invention.

### DETAILED DESCRIPTION OF EXEMPLARY EMBODIMENTS

The detailed description of exemplary embodiments herein makes reference to the accompanying drawings, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

The present invention includes the use of a credit card to facilitate payments to creditors that do not usually accept credit card payments. An exemplary method receives customer data, approves the transaction, processes the credit card charge, and pays the creditor. While the invention may be described with respect to credit cards, one skilled in the art will appreciate that any type of credit account, device or financial structure or system may be used to implement various aspects of the present invention. For example, the customer may use any type of transaction account discussed herein to pay facilitate the payment to creditors. The invention may be used to pay a portion or all of any obligation to any creditor. The obligation may include, for example, any type of loan, mortgage payment, automobile loan, boat loan, homeowner's dues, commercial lease, margin payment, securities obligation, rent payment, IRS, State or other government obligation, internet account obligation, credit card or other transaction account obligation and the like. The creditor may include, for example, a bank, a transaction card issuer, car company, loan company, mortgage company, homeowner association, stock broker, government entity and the like.

An “account” or “account number”, as used herein, may include any device, code, number, letter, symbol, digital certificate, smart chip, digital signal, analog signal, biometric or other identifier/indicia suitably configured to allow the consumer to access, interact with or communicate with the system (e.g., one or more of an authorization/access code, personal identification number (PIN), Internet code, other identification code, and/or the like). The account number may optionally be located on or associated with a rewards card, charge card, credit card, debit card, prepaid card, telephone card, embossed card, smart card, magnetic stripe card, bar code card, transponder, radio frequency card or an associated account. The system may include or interface with any of the foregoing cards or devices, or a fob having a transponder and RFID reader in RF communication with the fob. Although the system may include a fob embodiment, the invention is not to be so limited. Indeed, system may include any device having a transponder which is configured to communicate with RFID reader via RF communication. Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples can include watches, Internet enabled kitchen appliances, restaurant tables embedded with RF readers, wallets or purses with imbedded transponders, etc. The account number may be distributed and stored in any form of plastic, electronic, magnetic, radio frequency, wireless, audio and/or optical device capable of transmitting or downloading data from itself to a second device. Crediting or debiting may include causing the charging or debiting of a credit or charge card-type financial account, as applicable.

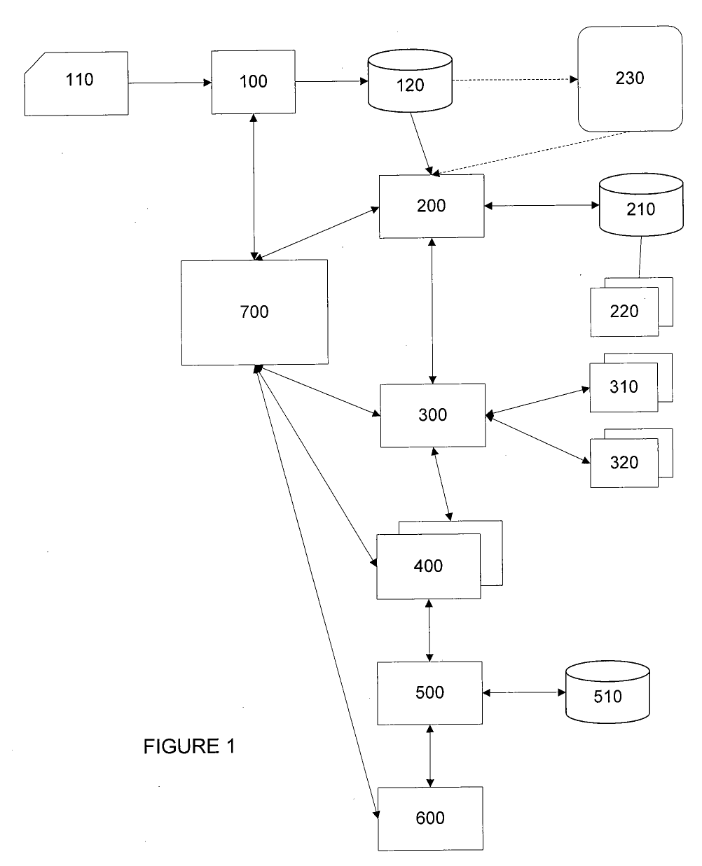

In accordance with the present invention, and with reference to FIG. 1, a third party payment credit card processing system comprises a customer interface 100, an approval engine 200, a scheduling engine 300, a service fee engine and schedule 400, a currency engine and database 500, a payment engine 600, and a reporting engine 700. An “engine” as used herein comprises any suitable software (e.g., operating systems and applications), hardware (e.g., processors), and network components configured to transmit, store (temporarily or permanently), and receive data in accordance with embodiments of the present invention. In these exemplary embodiments, the various processors and databases communicate via a network. Data representing operation of the various components may be transmitted via a network between the various processors and databases, including computing elements external to the system.

As used herein, “transmit” may include sending electronic data from one system component to another over a network connection. Additionally, as used herein, “data” may include encompassing information such as commands, queries, files, data for storage, and the like in digital or any other form. The system computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

### Customer Interface

A third party payment credit card processing system comprises a customer interface 100 for entering personal and financial information regarding a proposed transaction. A “customer” is defined as any user that desires to make a payment through the use of the system. For example, a customer may be retail customer, a business customer, a merchant conducting the transaction on behalf of any customer, an entity, software, hardware, individual, group and/or the like. Customer interface 100 may comprise any suitable technology configured to receive input from a customer through a variety of methods. In some embodiments, the customer interface is a web browser connected to a network. In other embodiments, the customer interface is a telephone.

Customer data 110 is submitted through customer interface 100 and stored in a customer database 120. In an exemplary embodiment, customer data 110 includes personal data and financial data. Personal data includes name, address, phone, email, and other data that suitably identifies a customer. Financial data includes data from the proposed transaction and other financial data about the customer. In various embodiments, financial data includes the creditor name, total amount owed to the creditor, payment frequency, amount of payment, date payment is due to creditor, secured or unsecured status of debt, and/or other similar information generally utilized in the financial services industry to identify and manage financial transactions.

### Approval Engine

A third party payment credit card processing system may comprise an approval engine 200 for approving/disapproving the proposed transaction. Many credit card issuers may fine a merchant should they incur too many cancellations or charge backs. A cancellation or charge back occurs when a customer disputes a charge or is a chronic non-payor of charges. As such, a service provider will want to ensure that the credit card issuer will make payment. Approval engine 200 receives customer data 110 from customer database 120. Approval engine 200 communicates with a database 210 that houses an approval schedule 220. Approval schedule 220 contains multiple criteria used to determine the amount a customer may be able to charge based on underlying debt, interest rate of card, credit score, payment frequency, and the like.

Approval engine 200 also comprises formulas used to calculate a final approval result. Many formulas exist for approving credit financial transactions and any such formula now known or hereafter devised is suitable for this invention. An approval result is any suitable result that indicates whether the proposed transaction should be completed. For example, an approval result may be an approved/not approved (i.e., yes/no) flag stored in a database. Alternatively, approval result may contain other criteria that condition the approval of the transaction. For example, the approval result may approve transactions only up to a specified dollar amount or that the transaction may only be completed with a card having an interest lower than a specified rate. The charge approval may also be contingent upon certain loan criteria such as, for example, large collateral, positive loan history, completing a certain number of regular payments, and/or the like. In some embodiments, customer data 110 may be sent via data feed to an external source 230 to calculate some or all of the approval result (e.g., a FICO® score).

### Scheduling Engine

The third party payment credit card processing system comprises a scheduling engine 300 for identifying and scheduling payments to creditors. The scheduling engine 300 identifies the frequency and the payment amounts that are required by the creditor. However, a customer or service provider may not desire to pay according to the creditor's schedule. So the scheduling engine is further configured to set actual payment date and amounts to be paid by the payment engine. In its embodiments, the scheduling engine 300 further comprises a creditor payment schedule 310 and a customer payment schedule 320. The creditor payment schedule 310 records the payment information needed to partially or fully satisfy the credit obligation to the creditor including the frequency and amount of payment. For example, a creditor may require that $1000 be paid on a monthly basis on a specified date. Scheduling engine 300 records this data in the creditor payment schedule 310. However, payments may be completed according to a customer payment schedule 320.

The customer payment schedule 320 records the amount and frequency of payments according to customer or service provider parameters. For example, using the example above, even though the creditor requires monthly payments of $1000, the customer may direct $500 payments to be charged to a credit card twice per month. In exemplary embodiments, the customer payment schedule may not be for an amount or frequency less than recorded on the creditor payment schedule. However, this is not a necessary condition. Certain circumstances may exist where a debtor may choose to incur creditor late charges or additional fees for late or insufficient payments.

### Service Fee Engine and Schedule

The third party payment credit card processing system comprises a service fee engine and schedule 400 to calculate and assess the service provider's fees for providing the system to the customer. In its embodiments, service fee engine 400 calculates and records the total fee charged to the customer. In its exemplary embodiments, the service fee comprises two distinct portions: (1) a usage fee for the usage of the service of the present invention, and (2) a transaction fee charged by the credit card issuer.

The usage fee structure may be any suitable structure charged to the customer for use of the processing system. For example, the service fee may be a per transaction fee based upon, for example, the amount of the transaction, the risk associated with the transaction, frequency of payment and the like. Alternatively, the service fee may be charged on a flat fee or subscription basis (e.g., $199.99 for one year or 50 transactions, etc.). Furthermore, the service fee may be discounted based on a variety of factors such as frequency of use, marketing promotions, monetary value of the transaction, number of credit cards needed to complete the transaction, existence of other accounts, and the like. However, any usage fee structure which compensates the provider of the present invention for its use is suitable.

The transaction fee is generally a fee charged by the credit card issuer for use of the credit card network. In various embodiments, the fee is expressed as a percentage of the amount charged. In exemplary embodiments, the transaction fee ranges from 0 to about 5% of the amount charged on the credit card. The system may also incorporate the use of loyalty or incentive points by earning loyalty points during any part of the process, or accepting (burning) loyalty points during any part of the process. For example, a customer may use existing loyalty points to reduce any fees charged for using the system, or a customer may earn points when timely paying of a loan.

### Currency Engine and Database

The third party payment credit card processing system comprises a currency engine 500 and database 510 for monitoring currency fluctuations and executing currency transactions. Currency engine 500 and database 510 maintains, in an embodiment, currency data typical of the foreign currency exchange markets including a daily record of international currency values and the currency conversion rates applied by the various credit card networks/interchanges for currency conversion. In its embodiments, the currency engine calculates the optimum location and currency for facilitating the transaction. Because of the difference in currency values and the amount that credit card banks or networks may charge for transactions in various countries, the currency engine can calculate and suggest the optimum country and currencies to use to complete the transaction or set of transactions. Also, there may be a difference between the time a customer charges a payment, and the time the service provider has to make the payment. In some embodiments, the currency engine may sum the payments needed for a specified time period in the future and purchase currency contracts in the foreign exchange markets. By utilizing this method, the service provider is able to employ various financial management strategies to boost profits or hedge risk.

### Payment Engine

The third party payment and credit card processing system comprises a payment engine 600 configured to send payment to various creditors. Methods of payments to creditors are known and will not be described here. As such, payments may be made via check, electronic network, or other method typical to financial transactions now known or hereafter devised to move money from one financial participant to another and are within the spirit of this invention. Payment engine 600 has a database that records the payment methods available to transfer payment to creditors. In some embodiments, the payment engine executes the payment in the mode that results in the lowest cost to the service provider of the present invention.

### Report Engine

The third party payment and credit card processing system comprises a report engine 800 that generates various reports for consumption by the customer or the service provider. In some embodiments, report engine 700 may be connected to customer interface 100 for delivery of reports to the customer or merchant. In other embodiments, the report engine has its own report interface wherein a service provider may access and report on various attributes of the system. In exemplary embodiments, the report engine is connected to all of the various engines and databases of the present invention and is able to utilize any of the data contained therein to generate useful reports. In yet other embodiments, the report engine is configured to provide audit trails sufficient to meet any regulatory or auditing requirements.

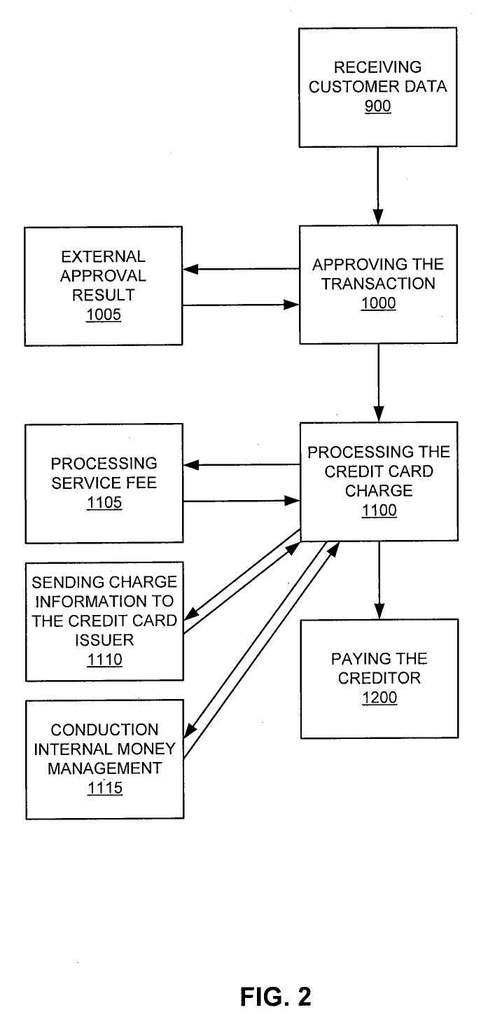

In accordance with the present invention and with reference to FIG. 2, a method for processing third party payments of a debt using a debtor's credit card comprises receiving customer data 900, approving the transaction 1000, processing the credit card charge 1100, and paying the creditor 1200.

The step of receiving customer data 900 comprises receiving into a computer-accessible storage medium personal data and financial data. In one embodiment, a customer accesses a web page via a network to enter customer data that is then input into the storage medium. In another embodiment, a customer visits a service provider's place of business wherein an employee of the service provider collects the customer data and inputs that information into the storage medium. Customer data is stored in a database. The database contains the necessary number of fields so that the customer can be suitably identified, the customer's financial situation can be analyzed, and the debt to the creditor can be paid.

The method for processing third party payments of a debt using a debtor's credit card comprises the step of approving the transaction 1000 to assess the creditworthiness of the customer. In various embodiments, customer data is transmitted via a network to an approval engine. Using multiple criteria, the proposed transaction is approved, not approved, or approved with conditions. In some embodiments, customer data is transmitted via a network to an external system 1005, such as a credit bureau and the like, to produce a partial or complete approval result.

The method for processing third party payments of a debt using a debtor's credit card comprises the step of processing the credit card charge 1100 so that payment is scheduled and the service provider receives a service fee. In its embodiments, the customer data is transmitted via a network to the scheduling engine. The scheduling engine records two schedules corresponding to the schedule with which the customer desires to pay the debt and the schedule that the debt must be paid (i.e., the schedule dictated by the creditor). The schedules comprise data representing the frequency and amount of the payments to be made.

In accordance with exemplary embodiments, processing the credit card charge comprises processing a service fee 1105. In its embodiments, the service fee engine calculates the charge to the customer for use of the system. In an exemplary embodiment, the charge is then added to the total to be charged on the customer's credit card. In other embodiments, the charge is collected in cash or some other form which is not a credit card. Additionally, in its embodiments, the credit card issuer may charge a fee to the service provider. This fee may be explicitly added to the amount directly paid by the customer, or implicit in the overall service fee charged to the customer.

In accordance with exemplary embodiments, processing the credit card charge comprises sending charge information to the credit card issuer 1110. In its embodiments, the charge information is transmitted to the credit card issuer via a network. In general, each credit card issuer may have its own terminal and/or network to conduct transactions. Any terminal and/or network now known or hereafter devised is suitable for processing credit card charges. Furthermore, in accordance with exemplary embodiments, once the charge is transmitted to the credit card issuer, the issuer transmits the funds to the service provider.

In accordance with exemplary embodiments, processing the credit card charge comprises conducting internal money management functions 1115. In its embodiments, a difference in the time funds are received from the credit card issuer and the time in which to pay the creditor may exist. As such, an arbitrage opportunity presents itself to increase the profits or decrease the risk of the use of the present invention. For example, money may be moved into and out of the currency markets to take advantage of this arbitrage opportunity.

In accordance with exemplary embodiments, paying the creditor 1200 comprises transmitting funds to the creditor of the debtor. In its embodiments, the scheduling engine transmits a pay order to the payment engine. The pay order comprises the creditor to be paid (e.g., name and address information) and the amount to be paid. Based on the creditor, the payment engine then determines the optimal method for transmitting payment to the creditor. The optimal method is determined by multiple criteria that include cost and speed. In some embodiments, the optimal method payments are made via an electronic network. In other embodiments, the optimal method is via check.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing system including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; financial institution data; and/or like data useful in the operation of the system. As those skilled in the art will appreciate, user computer may include an operating system (e.g., Windows NT, 95/98/2000, OS2, UNIX, Linux, Solaris, MacOS, etc.) as well as various conventional support software and drivers typically associated with computers. The computer may include any suitable personal computer, network computer, workstation, minicomputer, mainframe or the like. User computer can be in a home or business environment with access to a network. In an exemplary embodiment, access is through a network or the Internet through a commercially-available web-browser software package.

As used herein, the term “network” shall have its ordinary meaning in addition to including any electronic communications means which incorporates both hardware and software components of such. Communication among the parties may be accomplished through any suitable communication channels, such as, for example, a telephone network, an extranet, an intranet, Internet, point of interaction device (point of sale device, personal digital assistant (e.g., Palm Pilot®, Blackberry®), cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

The system contemplates uses in association with web services, utility computing, pervasive and individualized computing, security and identity solutions, autonomic computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks.

Firewall may include any hardware and/or software suitably configured to protect components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based and Packet Filtering among others. Firewall may be integrated within a web server or any other components or may further reside as a separate entity.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system.

Any of the communications, inputs, database, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service that receives a request from a web server, the request including a URL and an IP address. The web server retrieves the appropriate web pages and sends the data or applications for the web pages to the IP address. Web services are applications that are capable of interacting with other applications over a communications means, such as the internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003), hereby incorporated by reference.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, Macromedia Cold Fusion, Microsoft Active Server Pages, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

The system and method is described herein with reference to block diagrams and flowchart illustrations of methods, apparatus (e.g., systems), and computer program products according to exemplary embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the illustrated steps described herein may comprise in any number of configurations including the use of windows, web pages, web forms, popup windows, prompts and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Finally, it should be understood that various principles of the invention have been described in illustrative embodiments. However, many combinations and modifications of the above-described components, used in the practice of the invention, in addition to those not specifically described, may be varied and particularly adapted to specific environments and operating requirements without departing from those principles. Other variations and modifications of the present invention will be apparent to those of ordinary skill in the art, and it is the intent that such variations and modifications be covered.

What is claimed is:

1. A third party payment credit card processing system comprising:
a customer interface configured to receive customer data including a payment to a creditor;
an approval engine configured to receive the customer data from the customer interface, wherein the approval engine generates an approval result;
a scheduling engine configured to parse the customer data and record payment information required to satisfy a credit obligation;
a service fee engine configured to calculate and record a service fee at least partially based on the customer data; and,
a payment engine configured to execute the payment to a creditor.

2. The system of claim 1, further comprising a currency engine configured to monitor at least one currency pair and execute at least one foreign exchange currency transaction based at least partially on the customer data.

3. The system of claim 1, further comprising a report engine configured to generate and deliver a report to the customer interface.

4. The system of claim 1, wherein the customer interface comprises at least one of a web browser connected to a network and a telephone.

5. The system of claim 1, wherein the credit obligation comprises at least one of a mortgage payment, automobile loan, boat loan, credit card obligation, internet account obligation, homeowner dues and commercial lease.

6. The system of claim 1, wherein the scheduling engine further comprises a creditor payment schedule configured to record a date and an amount for which the amount is required by the creditor to be paid.

7. The system of claim 1, wherein the scheduling engine further comprises a customer payment schedule configured to record a date and an amount for which the amount is to be paid by the payment engine.

8. The system of claim 1, wherein the service fee comprises a usage fee and a transaction fee.

9. The system of claim 8, wherein the transaction fee is calculated according to criteria providing by the issuer of the credit card.

10. The system of claim 8, wherein the service fee comprises at least one of a flat fee, subscription fee, or percentage fee.

11. The system of claim 1, wherein the payment engine selects the payment method according to the lowest total cost to the service provider.

12. The system of claim 1, wherein the payment is a mortgage payment.

13. A method for processing third party payments of a debt using a debtor's credit card comprises the steps of:
receiving customer data and storing the customer data in a database;
analyzing the customer data according to pre-defined approval criteria and generating an approval result;
processing a credit card charge of the debtor according to a first schedule;
paying the creditor according to a second schedule.

14. The method of claim 13, wherein the customer data is received via a web page.

15. The method of claim 13, wherein the step of generating an approval result is partially performed by an external source.

16. The method of claim 13, wherein the step of processing a credit card charge further comprises at least one of: scheduling a payment and calculating a service fee.

17. The method of claim 13, wherein the step of processing a credit card charge further comprises scheduling a payment comprising recording a date and an amount for which the creditor dictates the date and the amount, and recording a date and an amount for which the customer dictates the date and the amount.

18. The method of claim 13, wherein the step of processing a credit card charge further comprises sending charge information to a credit card issuer.

19. The method of claim 13, wherein the step of processing a credit card charge further comprises receiving funds from a credit card issuer after sending information related to the credit card charge to the credit card issuer.

20. The method of claim 19, wherein the step of processing a credit card charge further comprises investing funds received from a credit card issuer related to the credit card charge, before the step of paying the creditor.
